(19) United States
(12) Patent Application Publication
(10) Pub. No.: US 2018/0173564 A1
(43) Pub. Date: Jun. 21, 2018

(54) Loading Balance System For Segmented Processing Request And Method Thereof

(71) Applicants: Inventec (Pudong) Technology Corporation, Shanghai (CN); Inventec Corporation, Taipei City (TW)

(72) Inventor: Long Chen, Shanghai (CN)

(21) Appl. No.: 15/623,014

(22) Filed: Jun. 14, 2017

(30) Foreign Application Priority Data
Dec. 20, 2016 (CN) 201611185726.2

(51) Int. Cl. G06F 9/48; G06F 17/30

(52) U.S. Cl. CPC G06F 9/4881; G06F 17/30994; G06F 17/30106

(57) ABSTRACT

The present disclosure illustrates a loading balance system for segmented processing request and a method thereof. In the loading balance system, a plurality of requests are respectively dispensed into receiving ends through a load balancing end, and the requests are added to a task queue of a processing end by each receiving end, so that the processing end may perform the requests within the task queue in the first-in first-out (FIFO) manner, and generate and write a message into a result file according to whether resource quota is full; and a browsing end may query the result file to check an execution result of the request. The mechanism is helpful to improve the loading capacity of the system.

### CROSS-REFERENCE TO RELATED APPLICATION

This application claims the benefit of Chinese Patent Application No. 201611185726.2, filed Dec. 20, 2016.

### BACKGROUND OF THE INVENTION

### 1. Field of the Invention

The present disclosure relates to a loading balance system and a method thereof, more particularly to a loading balance system which two-stage processes requests, and a method thereof

### 2. Description of the Related Art

In recent years, while internet network is being rapidly developed and popularized, various network services are available in market. Among the network services, electronic commerce attracts the most attention.

In general, for promotional or popularization purpose, an electronic commerce company may usually hold time-limit buy or quantity-limit buy activity to improve consumers' attention and desire to buy. However, the limit-buy promotion may cause a significant number of request packets transmitted to a server system in short time, which results in significantly-increasing load which the server system may not withstand, even the server system may crash because computing resources are exhausted. As a result, existing system for limit-buy promotion has the problem of poor loading capability of the system.

For this reason, some manufacturers develop loading balance technology in which multiple servers configured to distribute loading to prevent computing resources from being exhausted. However, the exiting loading balance technology may require more servers when the number of the request packets is increased, it increases a lot of hardware cost, so implementation and management of this technology is still limited and unable to effectively solve the problem of poor loading capability of the system.

Therefore, what is need is to develop a loading balance system to solve the problem of poor loading capability of the system.

### SUMMARY OF THE INVENTION

In order to solve the problem of poor system loading capability, the present disclosure is to provide a loading balance system for segmented processing request and a method thereof.

According to an embodiment, the present disclosure provides a loading balance system for segmented processing request, and the system includes at least one browsing end, a plurality of receiving ends, a loading balance end and a processing end. Each browsing end is configured to transmit at least one request and query a result file. Each receiving end is configured to add each request to a task queue, and transmit a confirmation message corresponding to the request to the browsing end corresponding to the request after the each request is added to the task queue. The loading balance end is configured to receive the at least one request from the at least one browsing end, and continuously transmit the at least one request to one of the plurality of receiving end respectively. The processing end includes the task queue and is configured to process each request in the task queue by a first-in first-out manner, and generate and write a success message corresponding to the request into the result file after the processing end confirms that a resource quota is not full, and generate and write a failure message corresponding to the request into the result file after the processing end confirms that the resource quota is full, wherein the processing end is configured to permit the browsing end to query the result file for checking result.

According to an embodiment, the present disclosure provides a loading balance method for segmented processing request, applicable to network environment comprising at least one browsing end, a loading balance end, a plurality of receiving ends and a processing end. The loading balance method includes following steps: transmitting at least one request from the at least one browsing end; in the loading balance end, receiving the at least one request from the at least one browsing end and continuously transmitting the at least one request to one of the plurality of receiving end respectively; in the receiving end, adding each of the at least one request to a task queue of the processing end in sequential order, and transmitting a confirmation message corresponding to the at least one request to the browsing end corresponding to the at least one request after each of the at least one request is added to the task queue; in the processing end, processing each request in the task queue by a first-in first-out manner, and generating and writing a success message corresponding to the request to the result file after the processing end confirms that a resource quota is not full, and generating and writing a failure message corresponding to the request to the result file after the processing end confirms that the resource quota is full; and in the processing end, permitting the at least one browsing end to query the result file for checking result.

According to above content, the difference between the present disclosure and the conventional technology is that, in the system and method of the present disclosure, the loading balance end dispenses the requests, which are transmitted from the at least one browsing end, to each of the receiving end respectively, and each receiving end adds the request to the task queue of the processing end, and the processing end executes the request in the task queue by the first-in first-out manner, and generates and writes the corresponding message into the result file according to whether the resource quota is full, and the at least one browsing end may query the result file to check the execution result for the request.

By using above technical means, the technical effect of improving the load capacity of server system may be achieved.

### BRIEF DESCRIPTION OF THE DRAWINGS

The structure, operating principle and effects of the present disclosure will be described in detail by way of various embodiments which are illustrated in the accompanying drawings.

FIG. 1 is a system block diagram of a loading balance system for segmented processing request, in accordance with the present disclosure.

FIG. 2 is a flowchart showing the steps in an operation of a loading balance method for segmented processing request, in accordance with the present disclosure.

FIG. 3 is a schematic view of an operation of online limit-buy of the present disclosure.

FIG. 4 is a schematic view of an operation of querying a result file of the present disclosure.

FIG. 5 is other schematic view of an operation of querying the result file of the present disclosure.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present invention. As used herein, the term “or” includes any and all combinations of one or more of the associated listed items.

Before illustration of the loading balance system segmented processing request and a method thereof of the present disclosure, the term defined in the present disclosure is described. A resource quota described in the present disclosure means a quantity of a preset product or service, which may be called limited product or service, such as a quantity of coupons, the number of massage services, and so on.

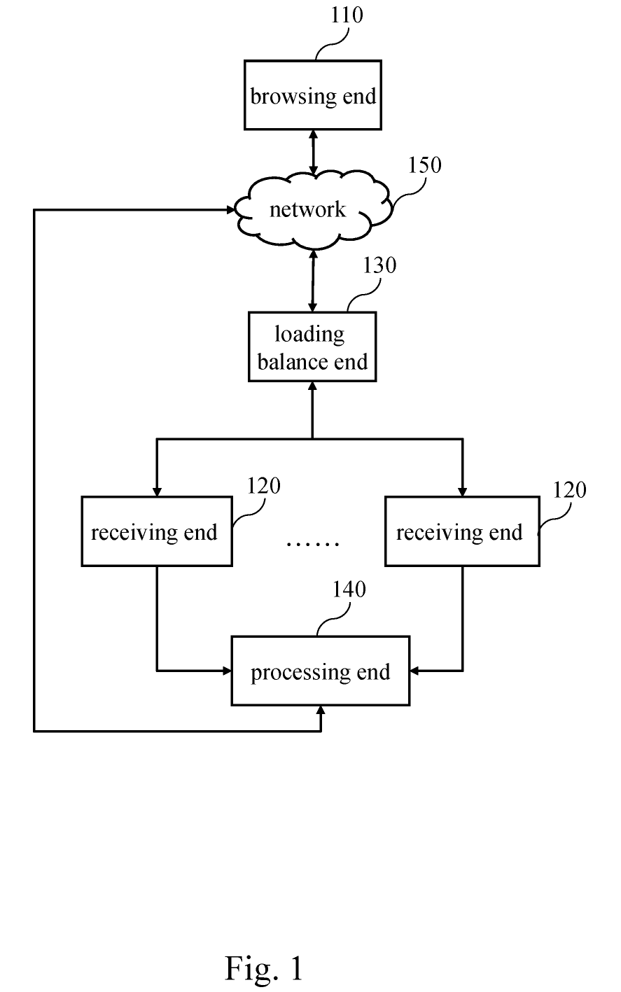

The following describes a loading balance system for segmented processing request and a method thereof of the present disclosure, with reference to the accompanying drawings. FIG. 1 is a system block diagram of a loading balance system for segmented processing request, in accordance with the present disclosure. The system includes a browsing end 110, a plurality of receiving ends 120, a loading balance end 130 and a processing end 140. The browsing end 110 is a computer device with network interconnection capability; for example, the browsing end 110 may be a personal computer, a tablet computer, a smartphone, a personal digital assistant and so on. The browsing end 110 is configured to browse a web page, transmit a request and query a result file of the processing end 140.

Each of the receiving ends 120 is configured to add each request to a task queue of the processing end 140 in sequential order, and transmit a confirmation message, which corresponds to the added request, to the browsing end 110 corresponding thereto after each request is added to the task queue. Particularly, the receiving end 120 does not execute the received request but transmits the received request to the processing end 140 to add the request to a task queue; and, after the request is added to the task queue, the receiving end 120 responds the confirmation message to the browsing end 110 which sends the request. As a result, the browsing end 110 may know that the request is accepted. It is to be noted that at this stage the browsing end 110 merely know that request is accepted, but may not confirm that the request is approved. In actual implementation, when the receiving end 120 fails to add the request to the task queue of the processing end 140, the receiving end 120 may generate and transmit a cancel message to the browsing end 110 corresponding to the request to inform the browsing end 110 that the request is accepted but may not be processed.

The loading balance end 130 is configured to receive the request from the browsing end 110, and continuously transmit the request to one of the receiving ends 120 separately. In actual implementation, the loading balance end 130 may perform a scheduling algorithm, such as round-robin (RR) algorithm, weight round-robin (WRR) algorithm, or waiting time (WT) algorithm, to dispense the request to one of the receiving ends 120. It is to be noted that any scheduling algorithm applicable to loading balance application is covered by the application field of the present disclosure. Furthermore, the request may include a source address and an identifier (ID), to facilitate the loading balance end 130 to select one of the receiving ends 120 according to the source address and the ID, and the loading balance end 130 may transmit the request to the selected receiving end 120. For example, suppose that there are three receiving ends, and when the source address is Taiwan and the ID is determined to be a VIP member, the loading balance end 130 transmits the request to the first receiving end; When the source address is Taiwan and the ID is determined to be a general member, the request is transmitted to the second receiving end; if none of above, the request is transmitted to the third receiving end.

The processing end 140 is configured to have a task queue, and process the request in the task queue by first-in first-out manner. After the processing end 140 confirms that resource quota thereof is not full, the processing end 140 generates a success message corresponding to the request, and writes the success message into a result file; when the processing end 140 confirms that the resource quota is full, the processing end 140 generates a failure message corresponding to the request, and writes the failure message into the result file. Furthermore, the processing end 140 permits the browsing end 110 to query the result file to check result. In actual implementation, the resource quota is predetermined as a value, and when the number of occurrence that the success message is generated is equal to the value, the resource quota is set to be full. For example, suppose that the resource quota is predetermined as five, and after the success message is generated by five times, the resource quota is changed from five to full. Furthermore, after the processing end 140 confirms that the resource quota is full, the processing end 140 may permit the receiving end 120 to write the request into the task queue, or not permit the receiving end 120 to add the request to the task queue, and delete all requests in the task queue.

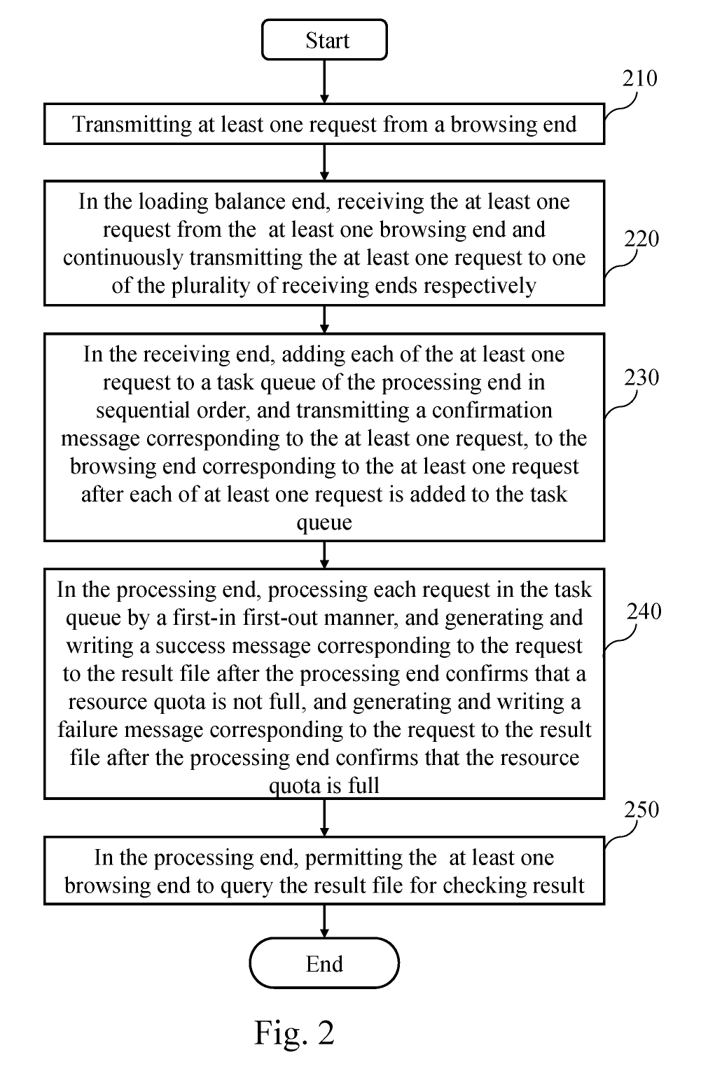

The following refers to FIG. 2, which is a flowchart showing the steps in an operation of a loading balance method segmented process request of the present disclosure. The method is applicable to network environment including the browsing end 110, the loading balance end 130, the receiving ends 120 and the processing end 140, and includes steps below. In a step 210, the browsing end 110 transmits the request. In a step 220, the loading balance end 130 receives the request from the browsing end 110, and continuously transmits the request to one of the receiving ends 120. In a step 230, the receiving end 120 may add the request to the task queue of the processing end 140, and after the request is added to the task queue, the receiving end 120 may transmit the confirmation message corresponding to the request to the browsing end 110 corresponding to the request. In a step 240, the processing end 140 may process each request in the task queue by the first-in first-out manner, and after the processing end 140 confirms that the resource quota is not full, the processing end 140 may generate the success message corresponding to the request, and write the success message into the result file; after the processing end 140 confirms that the resource quota is full, the processing end 140 may generate the failure message corresponding to the request, and write the failure message into the result file. In a step 250, the processing end 140 may permit the browsing end 110 to query the result file to confirm result. Through aforementioned steps, the requests from the browsing end 110 may be dispensed by the loading balance end 130 to the receiving ends 120 respectively, and each receiving end 120 may add the received request to the task queue of the processing end 140, and the processing end 140 may execute the request of the task queue by the first-in first-out manner, and generate and write the corresponding message into the result file according to whether the resource quota is full, and the browsing end 110 is permitted to query the result file to confirm a request execution result.

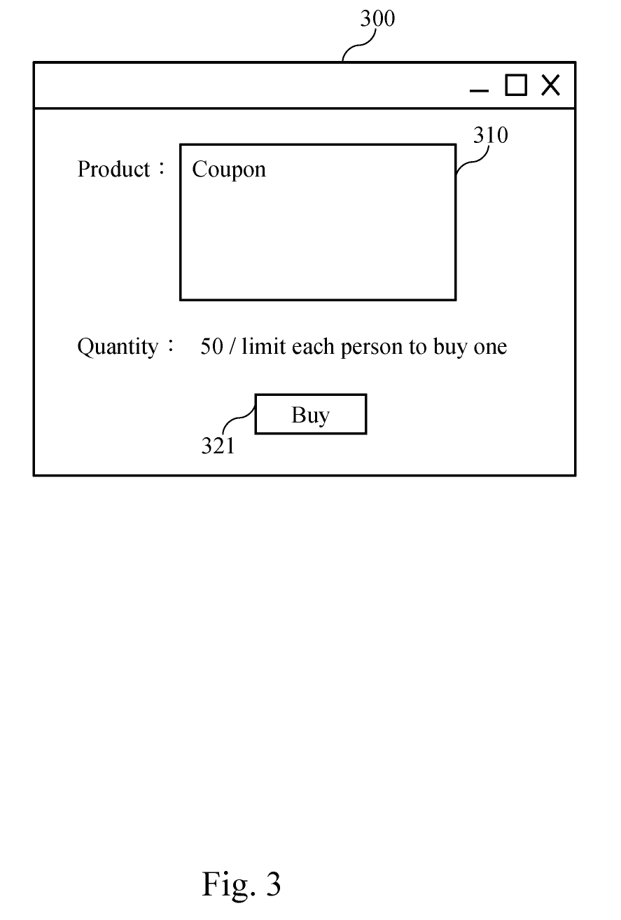

The following refers to an embodiment for illustration in cooperation with FIGS. 3 through 5. FIG. 3 is a schematic view of an operation of online limit-buy, in accordance with the present disclosure. In order to offer limited coupons, the processing end 140 may set a quantity of the coupons as the resource quota (such as, a value of fifty), and when the browsing end 110 opens the browser 300 to snap the coupon up online through network 150, the product area 310 of the web page displays a product name (such as, “Coupon”) and the resource quota is displayed on a quantity area. After the user operates the browsing end 110 to click the limit-buy icon 321, the browsing end 110 sends a transaction request to the loading balance end 130, and the loading balance end 130 may dispense the request to one of the receiving ends 120. Next, the receiving end 120 receiving the request may add the request to the task queue of the processing end 140, and then transmit the confirmation message to the browsing end 110, which sends the request, to inform that the request is received. The processing end 140 may execute the requests from the receiving ends 120 in sequential order by the first-in first-out manner. After the processing end 140 confirms that the resource quota is not full (that is, the coupon is still available), the processing end 140 generates and writes the success message corresponding to the request, into the result file; after the processing end 140 confirms that the resource quota is full (that is, the coupons are sold out), the processing end 140 generates and writes the failure message corresponding to the request, into the result file. In order to check whether the purchase of coupon is successful, the browsing end 110 may browse the processing end 140 through network 150 to query the result file for checking the result. Therefore, the limit-buy flow is separated into two parts, a first part of the limit-buy flow is to receive the request and a second part is to process the request. The receiving ends 120 merely receive the requests and return the confirmation messages without executing the request and replying the execution result, so that the processing speed of the receiving end 120 is very quick, and the browsing end 110 may instantly receive the response indicating that the request is accepted, thereby preventing the interconnection from being occupied continuously to wait the execution result. In the present disclosure, in order to know the execution result for the request, the browsing end 110 may browse the processing end 140 through network 150 to query the result file again.

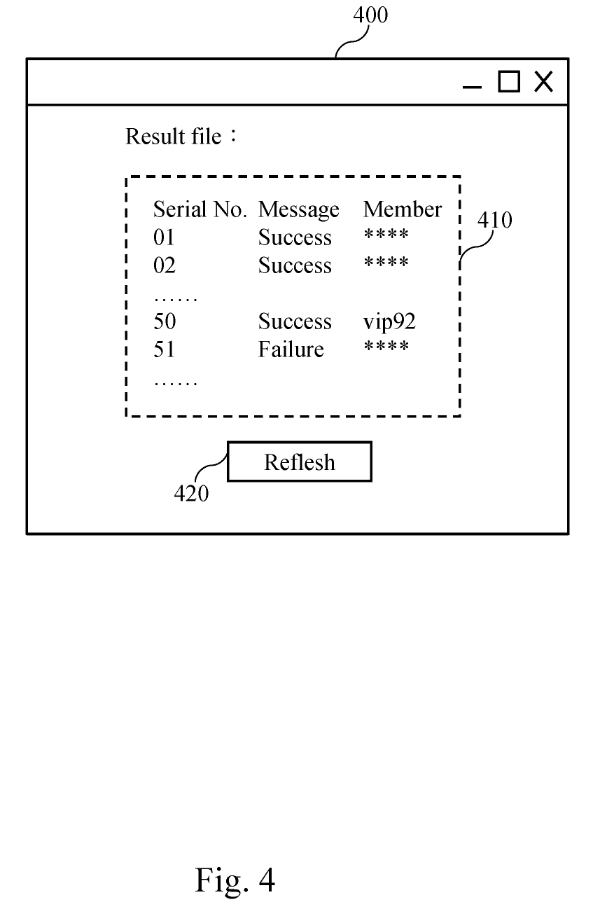

FIG. 4 is a schematic view of an operation of querying the result file of the present disclosure. According to above description, in order to know the execution result for the request, the browsing end 110 may browse the processing end 140 through network 150 to query the result file again. The following takes the resource quota with the value of fifty as an example. After the processing end 140 generates the corresponding message according to whether the resource quota is full, and writes the corresponding message into the result file, the browsing end 110 may log into the processing end 140 through the browser 400 (as shown in FIG. 4) to query the result file 410. Preferably, sensitive information contained in the result file may be masked by a symbol “*”, in consideration of protection for privacy or business information. Suppose that the processing end 140 writes messages into the result file 410 continuously, so the user may click a refresh icon 420 to update the displayed result file 410. Furthermore, besides displaying the whole result file 410 (as shown in FIG. 4), the browser 400 may display the message, which corresponds to the logged-in account, in the result file 410. For example, suppose that the account logged into the browsing end 110 is “vip02”, and after login, the browser may merely display “serial number: 02; message: successful; member: vip02”.

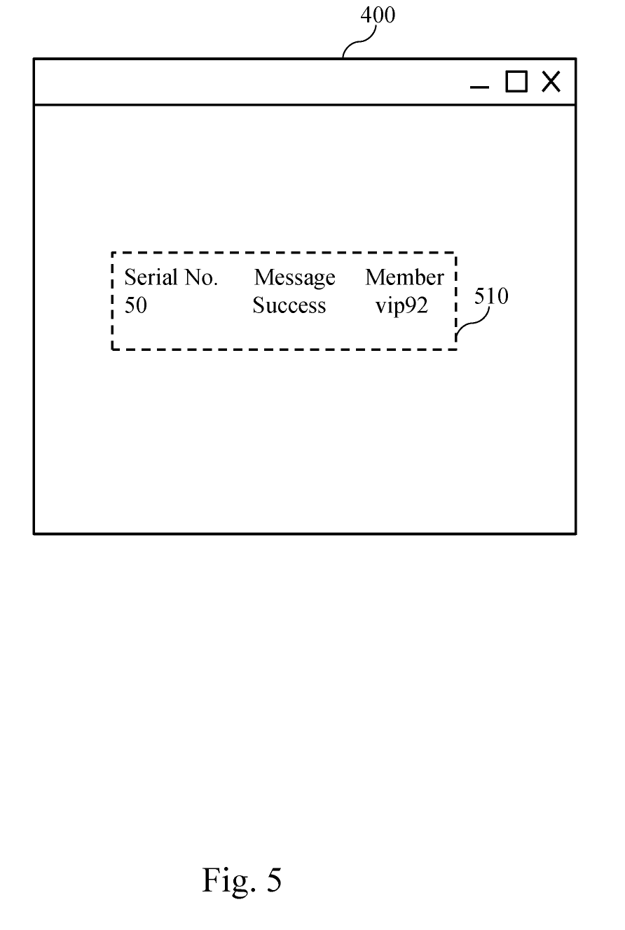

Please refer to FIG. 5, which is other schematic view of the operation of querying the result file of the present disclosure. In actual implementation, the processing end 140 may generate different result files corresponding to different browsing ends 110, that is, the result file may mere include the success message or the failure message corresponding to some browsing ends, but no other success message or failure message corresponding to other browsing ends. After the browsing end 110 receives the confirmation message, the browser 400 of the browsing end 110 is interconnected to the processing end 140 by the polling manner, to query the result file 510 corresponding thereto, and display the queried result file 510.

To summarize, the difference between the present disclosure and the conventional technology is that, in the system and method of the present disclosure, the loading balance end dispenses the request from the browsing end to one of the receiving ends, and the receiving end adds the request to the task queue of the processing end, and the processing end executes the requests in the task queue by the first-in first-out manner, and generates and writes the corresponding message into the result file according to whether the resource quota is full, and the browsing end may query the result file to check the execution result for the request. By using above technical means, the conventional technology problem may be solved, and the technical effect of improving the load capacity of server system.

The present disclosure disclosed herein has been described by means of specific embodiments. However, numerous modifications, variations and enhancements can be made thereto by those skilled in the art without departing from the spirit and scope of the invention set forth in the claims.

What is claimed is:

1. A loading balance system for segmented processing request, comprising:
at least one browsing end, wherein each of the at least one browsing end is configured to transmit at least one request and query a result file;
a plurality of receiving ends, wherein each of the plurality of receiving ends is configured to add each request to a task queue, and transmit a confirmation message corresponding to the request to the at least one browsing end corresponding to the request after the each request is added to the task queue;
a loading balance end configured to receive the at least one request from the at least one browsing end, and continuously transmit the at least one request to one of the plurality of receiving ends respectively; and
a processing end comprising the task queue and configured to process each request in the task queue by a first-in first-out manner, and generate and write a success message corresponding to the request into the result file after the processing end confirms that a resource quota is not full, and generate and write a failure message corresponding to the request into the result file after the processing end confirms that the resource quota is full, wherein the processing end is configured to permit the at least one browsing end to query the result file for checking result.

2. The loading balance system according to claim 1, wherein each of the at least one request comprises a source address and an identifier (ID), and the loading balance end selects one of the plurality of receiving ends according to the source address and the ID, and transmits the request to the selected receiving end.

3. The loading balance system according to claim 1, wherein the resource quota is preset as a value, and when the number of occurrence that the success message is generated is equal to the value, the resource quota is set to full.

4. The loading balance system according to claim 1, wherein after the processing end confirms that the resource quota is full, the processing end does not permit the receiving end to add the request to the task queue and deletes all requests in the task queue.

5. The loading balance system according to claim 1, wherein when the receiving end is unable to add the request to the task queue, the receiving end generates and transmits a cancel message to the at least one browsing end.

6. A loading balance method for segmented processing request, applicable to network environment comprising at least one browsing end, a loading balance end, a plurality of receiving ends and a processing end, the loading balance method comprising:
transmitting at least one request from the at least one browsing end;
in the loading balance end, receiving the at least one request from the at least one browsing end and continuously transmitting the at least one request to one of the plurality of receiving ends respectively;
in the receiving end, adding each of the at least one request to a task queue of the processing end in sequential order, and transmitting a confirmation message corresponding to the at least one request, to the at least one browsing end corresponding to the at least one request after each of at least one request is added to the task queue;
in the processing end, processing each request in the task queue by a first-in first-out manner, and generating and writing a success message corresponding to the request to the result file after the processing end confirms that a resource quota is not full, and generating and writing a failure message corresponding to the request to the result file after the processing end confirms that the resource quota is full; and
in the processing end, permitting the at least one browsing end to query the result file for checking result.

7. The loading balance method according to claim 6, wherein the request comprises a source address and an ID, and the loading balance end selects one of the plurality of receiving ends according to the source address and the ID, and transmits the request to the selected receiving end.

8. The loading balance method according to claim 6, wherein the resource quota is preset as a value, and when the number of occurrences that the success message is generated is equal to the value, the resource quota is set to full.

9. The loading balance method according to claim 6, wherein after the processing end confirms that the resource quota is full, the processing end does not permit the receiving end to add the request to the task queue and deletes all requests in the task queue.

10. The loading balance method according to claim 6, wherein when the receiving end is unable to add the request to the task queue, the receiving end generates and transmits a cancel message to the at least one browsing end.
